(19) United States
(12) Patent Application Publication
(10) Pub. No.: US 2015/0152230 A1
(43) Pub. Date: Jun. 4, 2015

(54) THERMOSETTING RESIN COMPOSITION AND ELECTRICAL DEVICE USING SAME

(71) Applicant: Hitachi, Ltd., Tokyo (JP)

(72) Inventors: Takahito Muraki, Tokyo (JP); Satoru Amou, Tokyo (JP); Hiroyuki Kagawa, Tokyo (JP)

(21) Appl. No.: 14/402,613

(22) PCT Filed: Apr. 10, 2013
(86) PCT No.: PCT/JP2013/060773

§ 371 Date: Nov. 20, 2014

(30) Foreign Application Priority Data
May 28, 2012 (JP) 2012-120605

(51) Int. Cl. C08J 3/24; H01F 27/24; H01F 27/28; C09D 171/00; H01B 3/42

(52) U.S. Cl. CPC C08J 3/24; C09D 171/00; H01B 3/427; H01F 27/2823; H01F 27/24; C08J 2371/10

(57) ABSTRACT

An object of the present invention is to provide: a resin composition which yields a hardened product having both processability/formability and thermal resistance; and an electrical device using the hardened product of the resin composition. A resin composition containing (A) polyarylene type thermoplastic polymer shown by Expression 1 and (B) chemical compound having at least two substituent groups capable of generating cationic species.

### TECHNICAL FIELD

The present invention relates: to a thermosetting resin composition excellent in thermal resistance; and in particular to a thermosetting resin composition suitable for the electrical insulation and fixation of an electrical device such as a motor.

### BACKGROUND ART

An electrical coil in a rotating machine such as a motor is processed with a resin composition with the aim of electrical insulation, heat dissipation during operation, the absorption of a beat note caused by electrical vibration, the fixation of a constituent material, and others. As resin compositions capable of exhibiting such functions: polyetherimide, polyether ether ketone, polyphenylene sulfide, etc. are mostly used as thermoplastic resin materials; and unsaturated polyester resin, epoxy resin, etc. are mostly used as thermosetting resin materials.

In order to cope with the downsizing and higher output of an electrical device in recent years, a better thermal resistance is desired. A resin of a higher thermal resistance class therefore is desired also as a resin used for the fixation layer and insulation layer of a rotor coil, a bobbin, or the like in an electrical device.

A thermosetting resin has been used primarily for such applications heretofore but a thermoplastic resin begins to be used also from the viewpoint of recyclability and formability in recent years.

In the case of a conventional thermoplastic resin however, it is necessary to raise a process temperature in order to increase thermal resistance and the requirement for a higher thermal resistance is hardly satisfied.

In order to solve the problem, methods of improving mechanical properties and thermal resistance by applying electron beam irradiation (Patent Literature 1) and the grafting of a crosslinkable group (Patent Literature 2) to a thermoplastic resin and thus introducing a crosslinking structure are known. In the case of a thermoplastic resin having a polyarylene structure excellent in thermal resistance however, such methods can hardly be applicable.

### CITATION LIST

### Patent Literature

### Patent Literature 1: Japanese Unexamined Patent Application Published No. 2010-189603

### Patent Literature 2: Japanese Unexamined Patent Application Published No. 2011-219681

### SUMMARY OF INVENTION

### Technical Problem

Thermal resistance described here means weight reduction caused by melting temperature and long term deterioration. In general the thermal resistance of a thermoplastic resin depends on the melting point of the resin. As a means for improving the thermal resistance of a thermoplastic resin is to introduce a crosslinking structure by electron beam irradiation or the grafting of a crosslinkable group. The means however is hardly applicable in the case of a thermoplastic resin having a polyarylene structure.

An object of the present invention is to provide: the introduction of a crosslinking structure to a thermoplastic resin having a polyarylene structure; a resin composition being resultantly obtained and showing a high thermal resistance; and an electrical device using the resin composition.

### Solution to Problem

The present inventors, as a result of earnest studies for solving the problems, have found that a resin composition containing (A) polyarylene type thermoplastic polymer shown by the following expression 1 and (B) chemical compound having at least two substituent groups capable of generating cationic species can yield a hardened product excellent in thermal resistance while maintaining the characteristics of the (A) component.

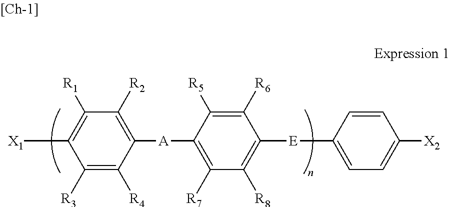

Here, at least one of R₁ to R₈ is a hydrogen atom, each of the remainder of R₁ to R₈ is a hydrogen atom or a hydrocarbon group having a carbon number of 1 to 9, each of A and E is, independently from each other, oxygen, sulfur, a sulf oxide group, a sulf one group, a carbonyl group, an amino group, or an alkylated amino group, and n represents a polymerization degree represented by an integer of one or more. Then each of X₁ and X₂ is, independently from each other, any one of a hydrogen atom, an alkyl group, a cycloalkyl group, an aralkyl group, an aryl group, a hydroxyl group, an alkylated hydroxyl group, an acylated hydroxyl group, a thiol group, an alkylated thiol group, an amino group, and an alkylated amino group.

### Advantageous Effects of Invention

The present invention makes it possible to provide: a resin composition having both formability and thermal resistance by post-crosslinking; and an electrical device using the resin composition.

### BRIEF DESCRIPTION OF DRAWINGS

FIG. 1 is a sectional view schematically showing a conductive wire subjected to insulating treatment by using a thermosetting resin composition according to the present invention.

FIG. 2 is a view schematically showing a coil for an electrical device subjected to insulating treatment by using a thermosetting resin composition according to the present invention.

FIG. 3A is a vertical sectional view schematically showing an example of a stator of a rotating electrical machine.

FIG. 3B is a plan sectional view schematically showing an example of a stator of a rotating electrical machine.

### DESCRIPTION OF EMBODIMENTS

In the present invention, the substituent groups capable of generating cationic species in the (B) chemical compound are preferably substituent groups capable of generating carbon cations such as carbocations or silyl cations.

The (A) thermoplastic polymer containing aromatic rings is preferably a polyarylene type thermoplastic polymer having an electron donor group of ortho- or para-orientation by introducing an atom of oxygen, nitrogen, sulfur, or the like into an aromatic ring.

Further, the (B) chemical compound having at least two substituent groups capable of generating cationic species has preferably at least two benzoxazine rings.

The number of the substituent groups capable of generating cationic species in the (B) chemical compound having at least two substituent groups capable of generating cationic species is preferably not less than 0.2 to less than 1.0 per one of the aromatic rings in the (A) thermoplastic polymer containing aromatic rings.

The (A) thermoplastic polymer containing aromatic rings is preferably crosslinked with the (B) chemical compound having at least two substituent groups capable of generating cationic species through a carbon-carbon bond.

A crosslinking site of the (A) thermoplastic polymer containing aromatic rings has preferably an orthohydroxyamino methyl phenyl framework.

The (B) chemical compound having at least two substituent groups capable of generating cationic species is preferably at least one kind shown by the expression 2.

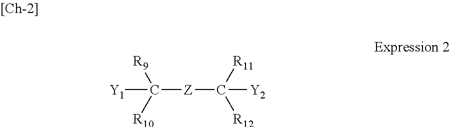

Here: each of the substituent groups Y₁ and Y₂ is any one of a halogen group, an acyloxy group, and a sulfonyloxy group; each of R₉ to R₁₂ is, independently from each other, a hydrogen atom or a hydrocarbon group having a carbon number of 1 to 9; and Z is any one of a bivalent aromatic group and an alkyl group and a cycloalkyl group, each of which has a carbon number of 1 to 9.

The (B) chemical compound having at least two substituent groups capable of generating cationic species is preferably at least one kind shown by the following expression 3.

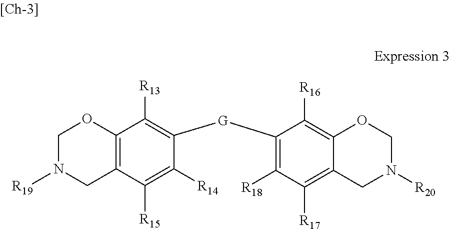

Here: each of R₁₃ to R₁₈ is, independently from each other, hydrogen atom or a hydrocarbon group having a carbon number of 1 to 9; each of R₁₉ and R₂₀ is, independently from each other, a hydrogen atom or an alkyl group, a cycloalkyl group, an aralkyl group, or an aryl group, each of which has a carbon number of 1 to 18; and G is any one of an alkyl group, a cycloalkyl group, an aryl group, an oxygen atom, a sulfur atom, a sulfinyl group, a sulf one group, an amino group, and an alkylated amino group, each of which has a bivalence.

The (A) thermoplastic polymer containing aromatic rings has preferably a styrene-equivalent molecular weight of not less than 1,000 and a glass-transition temperature of not lower than 90° C.

The thermal resistance rating of a crosslinked hardened product is preferably H-class or higher. The present invention provides: a conductive wire insulatively coated with the hardened product; and a coil for an electrical device having a magnetic core and the conductive wire being wound around the magnetic core and touching the crosslinked hardened product. Further, the present invention provides an electrical device using the coil for an electrical device.

Various components according to the present invention are explained hereunder.

### [(A) Component]

(A) polyarylene type thermoplastic polymer is a chemical compound having the structure shown by the expression 1, at least one of R₁ to R₈ is a hydrogen atom, and each of the remainder of R₁ to R₈ is a hydrogen atom or a hydrocarbon group having a carbon number of 1 to 9. Further, each of A and E shown in the expression 1 is, independently from, each other, oxygen, sulfur, a sulf oxide group, a sulf one group, a carbonyl group, an amino group, or an alkylated amino group. Furthermore, n represents a polymerization degree expressed by an integer of one or more. Moreover, each of X₁ and X₂ is, independently from each other, any one of a hydrogen atom, an alkyl group, a cycloalkyl group, an aralkyl group, an aryl group, a hydroxyl group, an alkylated hydroxyl group, an acylated hydroxyl group, a thiol group, an alkylated thiol group, an amino group, and an alkylated amino group.

When an atom of oxygen, nitrogen, sulfur, or the like is introduced into an aromatic ring of the polyarylene type thermoplastic polymer, the polyarylene type thermoplastic polymer contains preferably substituent group or an element showing an ortho- or para-orientation configuration.

Concretely,

(1) a polyphenylene ether derivative wherein: in R₁ to R₈, each of R₂, R₄, R₆, and R₈ is a methyl group and each of the others is a hydrogen atom; each of A and E is an oxygen atom; X₁ is a hydrogen atom; and X₂ is a hydroxyl group,
(2) a polyphenylene sulfide derivative wherein: each of R₁ to R₈ is a hydrogen atom; each of A and E is a sulfur atom; X₁ is a halogen atom; and X₂ is a halogen atom or a thiol group,
(3) a polyether ketone derivative wherein: each of R₁ to R₈ is a hydrogen atom; A is an oxygen atom; E is a carbonyl group; X₁ is a hydrogen atom; and X₂ is a hydroxyl group, and
(4) a polyether sulfone derivative wherein: each of R₁ to R₈ is a hydrogen atom; A is an oxygen atom; E is a sulfone group; and each of X₁ and X₂ is a halogen atom or a hydroxyl group
are named but the polyarylene type thermoplastic polymer is not limited to those derivatives. Further, from the viewpoint of melting temperature, n representing the polymerization degree is preferably set so that the molecular weight may be in the range of 1,000 to 5,000 in terms of styrene-equivalent molecular weight. Furthermore, from the viewpoint of thermal resistance, a resin having a glass-transition temperature of not lower than 90° C. is desirable.

Among those materials, from the viewpoint of securing both meltability and thermal resistance, a polyphenylene ether derivative and a polyphenylene sulfide derivative are desirable.

### [(B) Component]

As (B) chemical compound having at least two substituent groups capable of generating cationic species, there is the chemical compound group shown by the expression 2.

Here, as each of the substituent groups Y₁ and Y₂, a halogen group such as a chlorine atom, a bromine atom, or an iodine atom, an acyloxy group such as an acetoxy group or a trifluoroacetoxy group, or a sulfonyloxy group such as a p-toluenesulfonyloxy group, methanesulfonyloxy group, or a trifluoromethanesulfonyloxy group is named. Each of R₉ to R₁₂ is, independently from each other, a hydrogen atom or a hydrocarbon group having a carbon number of 1 to 9.

As Z, a bivalent aromatic group such as a phenylene group or a naphthylene group or an alkyl group or a cycloalkyl group, each of which has a carbon number of 1 to 9, is named. Concretely, α,α′-dichloroxylene, α,α′-dibromoxylene, α,α′-diiodoxylene, 1,4-bis(chloromethyl)naphthalene, 1,4-bis(bromomethyl)naphthalene, 4,4′-bis(chloromethyl)biphenyl, 4,4′-bis(bromomethyl)biphenyl, 4,4′-bis(iodomethyl)biphenyl, α,α′-diacetoxyxylene, α,α′-dimethanesulfonyloxyxylene, 4,4′-bis(trifluoroacetoxymethyl)biphenyl, or 4,4′-bis(trifluoromethylsulfonyloxymethyl)biphenyl is named but Z is not limited to those materials.

Further, benzoxazines shown by the expression 3 are also included in the chemical compound having at least two substituent groups capable of generating cationic species.

Here, each of R₁₃ to R₁₈ is, independently from each other, hydrogen atom or a hydrocarbon group having a carbon number of 1 to 9. Each of R₁₉ and R₂₀ is, independently from each other, a hydrogen atom or an alkyl group, a cycloalkyl group, an aralkyl group, or an aryl group, each of which has a carbon number of 1 to 18. G is any one of an alkyl group, a cycloalkyl group, an aryl group, an oxygen atom, a sulfur atom, a sulfinyl group, a sulfone group, an amino group, and an alkylated amino group, each of which has a bivalence.

Each of the benzoxazines is generally synthesized from a chemical compound having at least two phenol hydroxyl groups, formaldehyde, and an amine by an ordinary method. As a chemical compound having at least two phenol hydroxyl groups, bisphenyl A, bisphenol F, bisphenol S, or biphenol is named. Further as amines, aromatic amines such as aniline and aliphatic amines such as methylamine, ethylamine, propylamine, isopropylamine, and dodecylamine are named.

Among those materials, benzoxazines are desirable from the viewpoints of not having an elimination group acting as an impurity during hardening and the stability and thermal resistance after hardened.

With regard to a ratio between (A) polyarylene type thermoplastic polymer and (B) chemical compound having at least two substituent groups capable of generating cationic species, the number of the substituent groups capable of generating carbon cations in the (B) component is preferably not less than 0.2 to less than 1.0 per one of the aromatic rings in the (A) component.

When the ratio of the (B) component is small, crosslinking is insufficient, thermal resistance is inferior, and thus the case is undesirable. In contrast, when the ratio of the (B) component is large, crosslinking advances during forming, formability deteriorates conspicuously, and thus the case is undesirable.

An example of the structure of a hardened product obtained by crosslinking and hardening a thermosetting resin composition according to the present invention is shown as follows. The material shown by the expression 4 is a reactant obtained from a chemical compound shown by the expression 1 and a chemical compound shown by the expression 2.

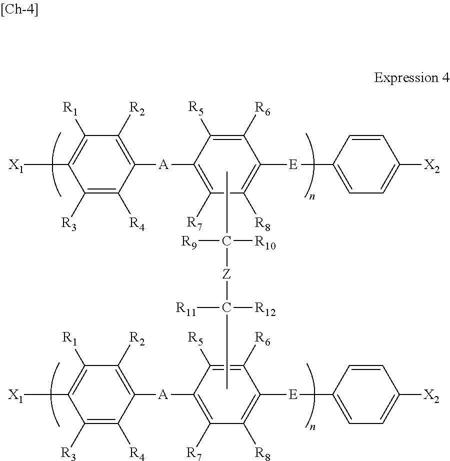

Here, R₁ to R₁₂, A, E, X₁, X₂, Z, and n are the same as described earlier.

Further, the structure of a reactant obtained from a chemical compound shown by the expression 1 and a chemical compound shown by the expression 3 is shown by the expression 5.

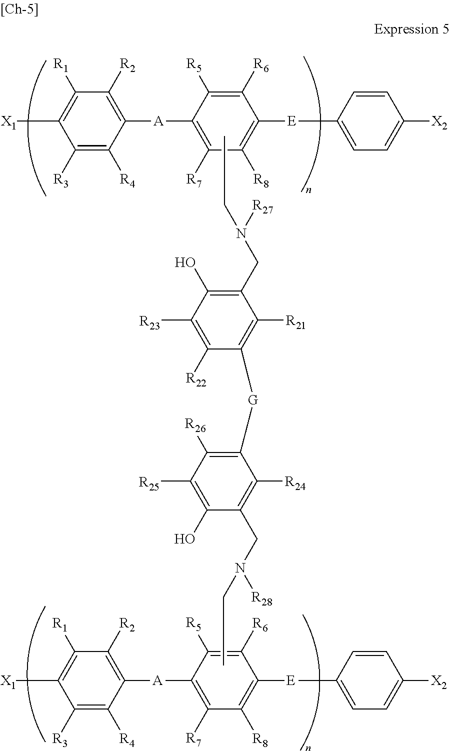

Here, R₁₃ to R₂₀ and G are the same as described earlier.

Then the reaction formula between a chemical compound shown by the expression 1 and a chemical compound shown by the expression 2 is shown by the expression 6 that will be shown later.

### [Other Arbitrary Components]

A solvent may be added to a thermosetting resin composition according to the present invention as one of the other arbitrary components for facilitating mixture if necessary. As the solvents, tetrahydrofuran, toluene, methyl ethyl ketone, acetone, etc. are named but, if remaining of a solvent and bulging of a resin coating during heating are taken into consideration, the boiling point is preferably not higher than 120° C. It is possible to use only one kind of them or use them by appropriately mixing two or more kinds of them.

Further if necessary, a metal catalyst may be added in order to accelerate hardening. As hardening accelerators, metal salts (metal salts of cobalt, zinc, zirconium, manganese, calcium, etc.) of naphthenic acid or octylic acid and various kinds of silver salts such as silver nitrate are named and it is possible to use only one kind of them or use them by appropriately mixing two or more kinds of them. Furthermore if necessary, an antioxidant can be blended. As antioxidants, quinones such as hydroquinone, para-tertiary butylcatechol, and pyrogallol, phosphites, and sulfides are named and it is possible to use only one kind of them or use them by appropriately mixing two or more kinds of them.

Moreover, various kinds of flame retardants for granting incombustibility and a lubricant for improving formability may be added. In addition, an inorganic particulate may be added to the resin composition. The inorganic particulate can be added by appropriate selection based on the characteristics required of a hardened resin. As the concrete required characteristics, the improvements of strength, a withstand voltage characteristic, incombustibility, thermal conductivity, etc. are named. As used particulates, silica, talc, calcium carbonate, magnesium oxide, aluminum hydroxide, aluminum oxide, boron nitride, mica, titanium oxide, zinc oxide, clay, whisker, etc. are named but the particulates are not limited to them. It is possible to use only one kind of the inorganic particulates or use them by appropriately mixing two or more kinds of them.

### [Method for Manufacturing Composition According to the Present Invention and Hardened Product Thereof]

In a method for manufacturing a thermosetting resin composition according to the present invention, firstly a resin composition containing (A) thermoplastic polymer containing aromatic rings and (B) chemical compound having at least two substituent groups capable of generating cationic species and other arbitrary components are heated, uniformly stirred, and mixed. When they are heated, the temperature range is preferably 200° C. or higher and depends on the viscosities and melting points of the (A) component and the (B) component. Further if necessary, a stirrer may be used when they are stirred and mixed.

Further in order to lower the temperature at heating, under the existence of a solvent, a resin composition containing (A) thermoplastic polymer containing aromatic rings and (B) chemical compound having at least two substituent groups capable of generating cationic species and other arbitrary components are heated, uniformly stirred, and mixed. When they are heated, the temperature range is preferably 150° C. or lower and depends on the boiling point of the solvent and the meltability of the (A) component and the (B) component. Further if necessary, a stirrer may be used when they are stirred and mixed.

In a method for hardening the composition, the composition is hardened preferably by heating the composition at 220° C. to 250° C. for 1 to 3 hours. The hardening temperature is adjusted appropriately in accordance with the application. With regard to the chemical structure of the hardened product, the hardened product is estimated to have a crosslinking structure by the following reaction when a polymer represented by the expression 1 is used as the (A) polymer and a chemical compound represented by the expression 2 is used as the (B) chemical compound.

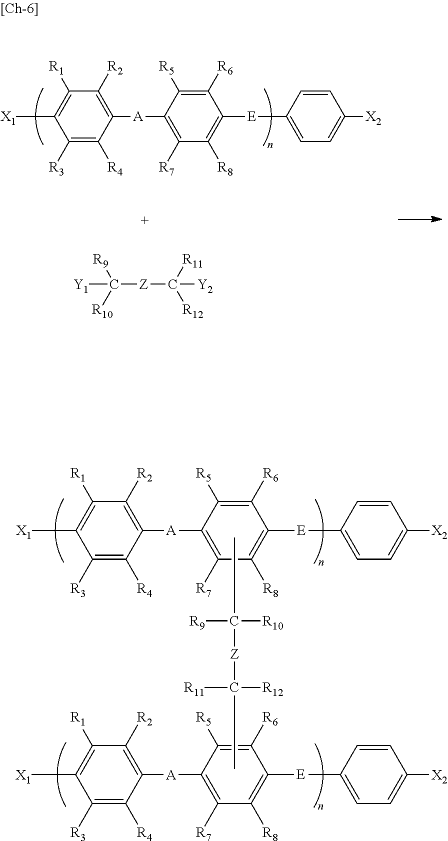

Expression 6

Here, R₁ to R₁₂, A, E, X₁, X₂, Z, and n are the same as described earlier.

When the composition is used for insulatively coating a conductive wire for example, the conductive wire is coated by extruding the composition over the conductive wire. As a conductive wire used here, aluminum, copper, copper the surface of which is coated with nickel, or the like is named but the conductive wire is not limited to those. Further, the shape of a conductive wire is also selectable arbitrarily, for example round or square, in accordance with the application. The coating method is an ordinary method and is not particularly limited.

A thermosetting resin composition according to the present invention can be used for insulatively coating a conductor and electrically insulating and fixing a coil for an electrical device such as a motor, for example.

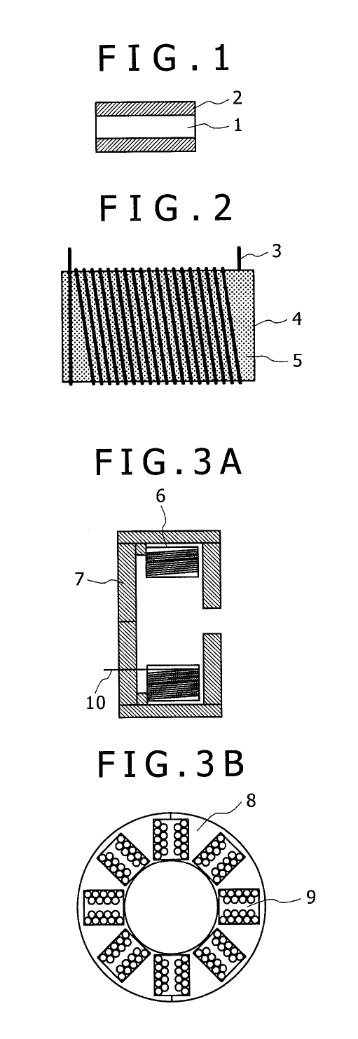

A coil for an electrical device subjected to insulating treatment by using a thermosetting resin composition according to the present invention is explained hereunder in reference to drawings. FIG. 1 is a view schematically showing a conductive wire subjected to insulating treatment by using a thermosetting resin composition according to the present invention. In the figure, the reference numeral 1 represents a conductor comprising copper or aluminum and the reference numeral 2 represents an insulating resin according to the present invention.

FIG. 2 is a view schematically showing a coil for an electrical device subjected to insulating treatment by using a thermosetting resin composition according to the present invention. In the figure, a conductor 3 according to the present invention is wound around a magnetic core 4 (comprising metal such as iron) of a coil and the circumference is subjected to insulating treatment by using an insulating material according to the present invention. The coil is subjected to treatment for fixing the coil if necessary. In the fixing treatment, the wound coil is coated with a resin composition for fixation by a dipping method, a trickle impregnation method, or the like. Successively, the composition is heated and hardened at a prescribed temperature for a prescribed time to form a hardened product and thus an insulation-treated coil for an electrical device is obtained.

FIGS. 3A and 3B are views schematically showing the configuration of a rotating electrical machine as an example of an electrical device. FIG. 3A is a vertical sectional view of a stator and FIG. 3B is a plan sectional view of the stator. In the figures, stator coils 6 arranged in slots 9 formed in a cylindrical stator magnetic core 8 are fixed to a housing 7. Although it is not shown in the figures, a rotator magnetic core concentrically rotating in the interior of the stator magnetic core is provided. A plurality of coils around which a coated conductive wire is wound are formed by using a plurality of slots formed in the axial direction in either or both of the stator magnetic core and the rotator magnetic core. The stator is obtained by winding a conductive wire insulatively coated with a resin composition according to the present invention in the slots of the stator.

The stator and the rotator are assembled by an ordinary method and thus a rotating electrical machine using the stator coil comprising the conductive wire insulatively coated with the composition is obtained. The reference numeral 10 represents a terminal.

The present invention is hereunder explained by examples but is not limited to the examples. For example, the use of both the chemical compounds shown by the expressions 2 and 3 in combination falls within the scope of the present invention and to form a composite insulating material by combining a thermosetting resin composition according to the present invention with another insulating material also falls within the scope of the present invention.

### Example 1

50 parts by weight of polyphenylene ether having a molecular weight of 2,500 and 12 parts by weight of α,α′-dimethanesulfonyloxyxylene are dissolved in tetrahydrofuran at room temperature, and thereafter dried and pelletized. A hardened product is obtained by heating the pellet at 250° C. for one hour. The pellet is heated on a hot plate but does not melt. Further, the thermal resistance evaluated by a temperature at which 5% weight reduction occurs for 20,000 hours is 180° C. or higher in heat acceleration test and it is confirmed that a thermal resistance rating of H-class or higher is satisfied. H-class or higher in the present invention means that the thermal resistance rating based on 5% weight reduction is H-class or higher.

### Example 2

50 parts by weight of polyphenylene ether having a molecular weight of 2,500 and 61 parts by weight of α,α′-dimethanesulfonyloxyxylene are dissolved in tetrahydrofuran at room temperature and thereafter dried and pelletized. A hardened product is obtained by heating the pellet at 250° C. for one hour. The pellet is heated on a hot plate but does not melt. Further, the thermal resistance evaluated by a temperature at which 5% weight reduction occurs for 20,000 hours is 180° C. or higher in heat acceleration test and it is confirmed that a thermal resistance rating of H-class or higher is satisfied.

### Example 3

50 parts by weight of polyphenylene ether having a molecular weight of 2,500 and 50 parts by weight of benzoxazine synthesized from bisphenol F, formaldehyde, and aniline are dissolved in tetrahydrofuran at room temperature and thereafter dried and pelletized. A hardened product is obtained by heating the pellet at 250° C. for one hour.

The pellet is heated on a hot plate but does not melt. Further, the thermal resistance evaluated by a temperature at which 5% weight reduction occurs for 20,000 hours is 180° C. or higher in heat acceleration test and it is confirmed that a thermal resistance rating of H-class or higher is satisfied.

### Example 4

50 parts by weight of polyphenylene sulfide having a molecular weight of 2,500 and 50 parts by weight of benzoxazine synthesized from bisphenol F, formaldehyde, and aniline are thermally conditioned, kneaded, and pelletized. A hardened product is obtained by heating the pellet at 250° C. for one hour.

The pellet is heated on a hotplate but does not melt. Further, the thermal resistance evaluated by a temperature at which 5% weight reduction occurs for 20,000 hours is 180° C. or higher in heat acceleration test and it is confirmed that a thermal resistance rating of H-class or higher is satisfied.

### Example 5

50 parts by weight of polyphenylene sulfide having a molecular weight of 2,500 and 50 parts by weight of benzoxazine synthesized from bisphenol S, formaldehyde, and aniline are thermally conditioned, kneaded, and pelletized. A hardened product is obtained by heating the pellet at 250° C. for one hour.

The pellet is heated on a hot plate but does not melt. Further, the thermal resistance evaluated by a temperature at which 5% weight reduction occurs for 20,000 hours is 180° C. or higher in heat acceleration test and it is confirmed that a thermal resistance rating of H-class or higher is satisfied.

### Example 6

50 parts by weight of polyphenylene sulfide having a molecular weight of 2,500 and 50 parts by weight of α,α′-di(trifluoroacetoxy)xylene are thermally conditioned, kneaded, and pelletized. A hardened product is obtained by heating the pellet at 250° C. for one hour.

The pellet is heated on a hot plate but does not melt. Further, the thermal resistance evaluated by a temperature at which 5% weight reduction occurs for 20,000 hours is 180° C. or higher in heat acceleration test and it is confirmed that a thermal resistance rating of H-class or higher is satisfied.

### Example 7

50 parts by weight of polyphenylene sulfide having a molecular weight of 2,500 and 50 parts by weight of α,α′-di(trifluoroacetoxy)xylene are thermally conditioned, kneaded, and pelletized. A conductive wire insulatively coated with polyphenylene sulfide is obtained by using an aluminum round wire as the core wire, applying resin extrusion coating, and thus forming an extrusively coated resin layer 60 μm in thickness. It is confirmed that the conductive wire satisfies a thermal resistance rating of H-class or higher.

### Example 8

50 parts by weight of polyphenylene sulfide having a molecular weight of 2,500 and 50 parts by weight of benzoxazine synthesized from bisphenol F, formaldehyde, and aniline are thermally conditioned, kneaded, and pelletized. A conductive wire insulatively coated with polyphenylene sulfide is obtained by using a copper round wire as the core wire, applying resin extrusion coating, and thus forming an extrusively coated resin layer 60 μm in thickness. It is confirmed that the conductive wire satisfies a thermal resistance rating of H-class or higher.

### Example 9

50 parts by weight of polyphenylene sulfide having a molecular weight of 2,500 and 50 parts by weight of benzoxazine synthesized from bisphenol S, formaldehyde, and aniline are thermally conditioned, kneaded, and pelletized. A conductive wire insulatively coated with polyphenylene sulfide is obtained by using a copper round wire as the core wire, applying resin extrusion coating, and thus forming an extrusively coated resin layer 50 μm in thickness. It is confirmed that the conductive wire satisfies a thermal resistance rating of H-class or higher.

### Example 10

50 parts by weight of polyphenylene sulfide having a molecular weight of 2,500 and 50 parts by weight of benzoxazine synthesized from bisphenol F, formaldehyde, and aniline are thermally conditioned, kneaded, and pelletized. A conductive wire insulatively coated with polyphenylene sulfide is obtained by using a copper square wire as the core wire, applying resin extrusion coating, and thus forming an extrusively coated resin layer 60 μm in thickness. It is confirmed that the conductive wire satisfies a thermal resistance rating of H-class or higher.

### Example 11

50 parts by weight of polyphenylene ether having a molecular weight of 2,500 and 50 parts by weight of benzoxazine synthesized from bisphenol F, formaldehyde, and aniline are dissolved in tetrahydrofuran at room temperature and thereafter dried and pelletized. A conductive wire insulatively coated with polyphenylene ether is obtained by using a copper square wire as the core wire, applying resin extrusion coating, and thus forming an extrusively coated resin layer 40 μm in thickness. It is confirmed that the conductive wire satisfies a thermal resistance rating of H-class or higher.

### Comparative Example 1

Polyphenylene ether having a molecular weight of 2,500 is pelletized and the pellet is heated on a hot plate and resultantly melts.

### Comparative Example 2

Polyphenylene sulfide having a molecular weight of 2,500 is pelletized and the pellet is heated on a hot plate and resultantly melts.

### Comparative Example 3

Polyphenylene ether having a molecular weight of 2,500 is pelletized. A conductive wire insulatively coated with polyphenylene sulfide is obtained by using a copper round wire as the core wire, applying resin extrusion coating, and thus forming an extrusively coated resin layer 60 μm in thickness. The insulative coating melts when the extrusively coated wire is heated.

### Comparative Example 4

Polyphenylene sulfide having a molecular weight of 2,500 is pelletized. A conductive wire insulatively coated with polyphenylene sulfide is obtained by using a copper round wire as the core wire, applying resin extrusion coating, and thus forming an extrusively coated resin layer 60 μm in thickness. The insulative coating melts when the extrusively coated wire is heated.

From the results, it is verified that a resin composition comprising (A) thermoplastic polymer containing aromatic rings and (B) chemical compound having at least two substituent groups capable of generating cationic species exhibits a good formability and a high thermal resistance. In the present invention, that formability is good means that a wire or a rod of a conductor or the like can be coated well by extrusion.

### Example 12

A twist pair type coil described in JIS C3003 is manufactured with a conductive wire manufactured in Example 10.

As a result of evaluating the insulation characteristics of the manufactured coil in heat acceleration test, the thermal resistance is 180° C. or higher and it is confirmed that a thermal resistance rating of H-class or higher is satisfied.

### Example 13

A twist pair type coil described in JIS C3003 is manufactured with a conductive wire manufactured in Example 11.

As a result of evaluating the insulation characteristics of the manufactured coil in heat acceleration test, the thermal resistance is 180° C. or higher and it is confirmed that a thermal resistance rating of H-class or higher is satisfied.

### Comparative Example 5

A twist pair type coil described in JIS C3003 is manufactured with a conductive wire manufactured in Comparative Example 4.

As a result of evaluating the insulation characteristics of the manufactured coil in heat acceleration test, the resin melts and the thermal resistance cannot be obtained.

### Example 15

A stator using a conductive wire manufactured in Example 10 as coils is obtained. The stator satisfies a thermal resistance rating of H-class or higher. In contrast, a motor using a conductive wire shown in Comparative Example 3 does not satisfy a thermal resistance rating of H-class or higher.

### LIST OF REFERENCE SIGNS

1 Insulating resin
2 Conductor
3 Coated conductor
4 Magnetic core
5 hardened resin
6 Stator coil
7 Housing
8 Stator magnetic core
9 Slot
10 Terminal

1. A thermosetting resin composition containing (A) polyarylene type thermoplastic polymer containing aromatic rings and being shown by the following expression 1 and (B) chemical compound having at least two substituent groups capable of generating cationic species, 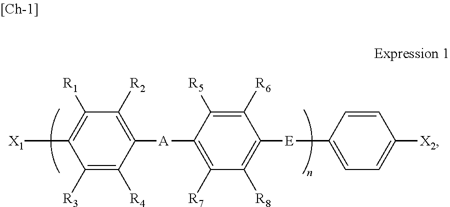
here: at least one of R₁ to R₈ is a hydrogen atom; each of the remainder of R₁ to R₈ is a hydrogen atom or a hydrocarbon group having a carbon number of 1 to 9; each of A and E is, independently from each other, oxygen, sulfur, a sulfoxide group, a sulfone group, a carbonyl group, an amino group, or an alkylated amino group; n represents a polymerization degree represented by an integer of one or more; and then each of X₁ and X₂ is, independently from each other, any one of a hydrogen atom, an alkyl group, a cycloalkyl group, an aralkyl group, an aryl group, a hydroxyl group, an alkylated hydroxyl group, an acylated hydroxyl group, a thiol group, an alkylated thiol group, an amino group, and an alkylated amino group.

2. A thermosetting resin composition according to claim 1, wherein, in the (B) chemical compound, the substituent groups capable of generating cationic species are substituent groups capable of generating carbon cations.

3. A thermosetting resin composition according to claim 1, wherein the (A) thermoplastic polymer containing aromatic rings is a polyarylene type thermoplastic polymer having an electron donor group.

4. A thermosetting resin composition according to claim 1, wherein the (B) chemical compound having at least two substituent groups capable of generating cationic species has at least two benzoxazine rings.

5. A thermosetting resin composition according to claim 1, wherein the number of the substituent groups capable of generating cationic species in the (B) chemical compound having at least two substituent groups capable of generating cationic species is not less than 0.2 to less than 1.0 per one of the aromatic rings in the (A) thermoplastic polymer containing aromatic rings.

6. A thermosetting resin composition according to claim 1, wherein the (A) thermoplastic polymer containing aromatic rings is crosslinked with the (B) chemical compound having at least two substituent groups capable of generating cationic species through a carbon-carbon bond.

7. A thermosetting resin composition according to claim 1, wherein a crosslinking site of the (A) thermoplastic polymer containing aromatic rings has an orthohydroxyamino methyl phenyl framework.

8. A thermosetting resin composition according to claim 1, wherein the (B) chemical compound having at least two substituent groups capable of generating cationic species is shown by the expression 2, 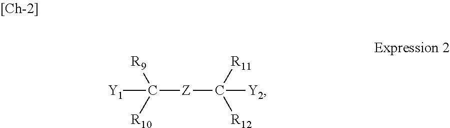
here: each of the substituent groups Y₁ and Y₂ is any one of a halogen group, an acyloxy group, and a sulfonyloxy group; each of R₉ to R₁₂ is, independently from each other, a hydrogen atom or a hydrocarbon group having a carbon number of 1 to 9; and Z is any one of a bivalent aromatic group and an alkyl group and a cycloalkyl group, each of which has a carbon number of 1 to 9.

9. A thermosetting resin composition according to claim 1, wherein the (B) chemical compound having at least two substituent groups capable of generating cationic species is at least one kind shown by the expression 3, 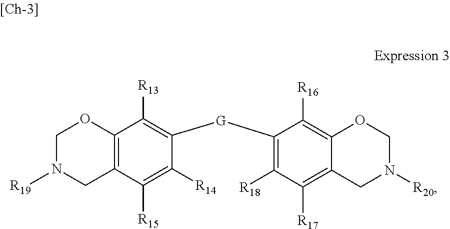
here: each of R₁₃ to R₁₈ is, independently from each other, a hydrogen atom or a hydrocarbon group having a carbon number of 1 to 9; each of R₁₉ and R₂₀ is, independently from each other, a hydrogen atom or an alkyl group, a cycloalkyl group, an aralkyl group, or an aryl group, each of which has a carbon number of 1 to 18; and G is any one of an alkyl group, a cycloalkyl group, an aryl group, an oxygen atom, a sulfur atom, a sulfinyl group, a sulfone group, an amino group, and an alkylated amino group, each of which has a bivalence.

10. A hardened product of a thermosetting resin composition according to claim 1, wherein the (A) thermoplastic polymer containing aromatic rings has a styrene-equivalent molecular weight of not less than 1,000 and a glass-transition temperature of not lower than 90° C.

11. A hardened product of a thermosetting resin composition according to claim 1, wherein the thermal resistance rating is H-class or higher.

12. A hardened product of a thermosetting resin composition having a structure shown by the following expression 4, 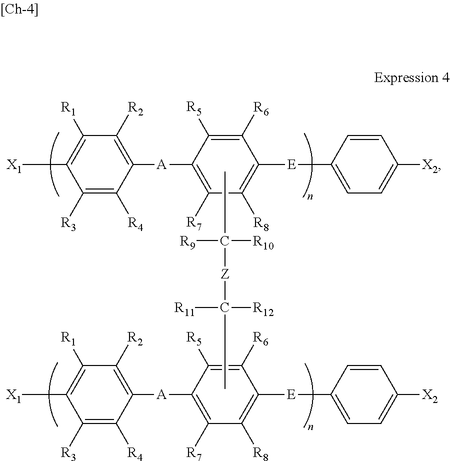
here: at least one of R₁ to R₈ is a hydrogen atom, each of the remainder of R₁ to R₈ is a hydrogen atom or a hydrocarbon group having a carbon number of 1 to 9; each of A and E is, independently from each other, oxygen, sulfur, a sulfoxide group, a sulfone group, a carbonyl group, an amino group, or an alkylated amino group; n represents a polymerization degree represented by an integer of one or more; each of X₁ and X₂ is, independently from each other, any one of a hydrogen atom, an alkyl group, a cycloalkyl group, an aralkyl group, an aryl group, a hydroxyl group, an alkylated hydroxyl group, an acylated hydroxyl group, a thiol group, an alkylated thiol group, an amino group, and an alkylated amino group; and Z is any one of a bivalent aromatic group and an alkyl group and a cycloalkyl group, each of which has a carbon number of 1 to 9.

13. A hardened product of a thermosetting resin composition having a structure shown by the following expression 5, 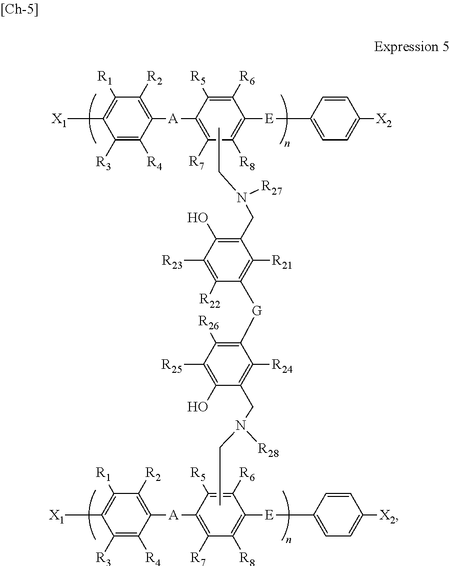
here: each of R₁₃ to R₁₈ is, independently from each other, a hydrogen atom or a hydrocarbon group having a carbon number of 1 to 9; each of R₁₉ and R₂₀ is, independently from each other, a hydrogen atom or an alkyl group, a cycloalkyl group, an aralkyl group, or an aryl group, each of which has a carbon number of 1 to 18; G is any one of an alkyl group, a cycloalkyl group, an aryl group, an oxygen atom, a sulfur atom, a sulfinyl group, a sulfone group, an amino group, and an alkylated amino group, each of which has a bivalence.

14. A conductive wire insulatively coated with a hardened product according to claim 10.

15. A coil for an electrical device, wherein the coil has: a magnetic core; and a conductive wire being wound around the magnetic core and touching a hardened product of a thermosetting resin composition according to claim 10.

16. An electrical device using a coil for an electrical device according to claim 15.
